(19) United States
(12) Patent Application Publication
(10) Pub. No.: US 2006/0017987 A1
(43) Pub. Date: Jan. 26, 2006

(54) Scan device capable of detecting an open/close state of a cover

(75) Inventors: Yen-Cheng Chen, Hsin Chu City (TW); Sheng-Chung Tsai, Chu Pei City (TW)

Correspondence Address: BIRCH STEWART KOLASCH & BIRCH, PO BOX 747, FALLS CHURCH, VA, 22040-0747, US

(73) Assignee: AVISION INC.

(21) Appl. No.: 11/179,592

(22) Filed: Jul. 13, 2005

(30) Foreign Application Priority Data
Jul. 23, 2004 (TW) 093122178

(51) Int. Cl. H04N 1/04

(52) U.S. Cl. 358/474

(57) ABSTRACT

A scan device includes a body, a scanning module disposed in the body, a cover pivotably connected to the body, an optical sensor and a power supply controller. The body has a scan platen, on which a document may be placed. The optical sensor for receiving ambient light and correspondingly outputting an open-state signal is disposed on the cover or body. The power supply controller electrically connected to the optical sensor controls power supplied to the scanning module according to the open-state signal.

### BACKGROUND OF THE INVENTION

1. Field of the Invention

The invention relates to a scan device capable of detecting an open/close state of a cover, and more particularly to a scan device for detecting an open/close state of a cover by sensing ambient light.

2. Description of the Related Art

A scan device applied to current copiers, scanners, multi-function peripherals and the like, has to preheat a lamp before a scanning procedure is made, such that the luminance of the scanning light source approaches a stable state and a better scanning result may be obtained.

The procedure of preheating the lamp may be enabled manually. In order to make the scan device in a more human-oriented manner, it is advantageous to the saving of time if the lamp is preheated as a cover is lifted up.

In order to detect an open/close state of the cover, a light emitting diode (LED) sensor is conventionally disposed under the glass platen. The open state of the cover may be detected in a normal condition by outputting a light ray to the cover and receiving the light ray reflected by the cover. However, this detecting device has a narrow effective detecting range, and cannot detect the open state of the cover when a document is placed on the glass platen. Another conventional method is to utilize a Hall effect sensor to detect the open state of the cover. However, such a sensor needs an electromagnetic field being created, and the implementation thereof is more complicated.

FIG. 1 shows a device of controlling an ON/OFF state of a scanner power by a cover, as disclosed in Taiwan Patent Publication Number 566778. Referring to FIG. 1, the scanner includes a casing 101, a cover 102 and a glass platen 103. The cover 102 is pivotably connected to the casing 101 through a rotating shaft structure 104. The casing 101 has a top plate 105 formed with a slot 106. A sensor 107 corresponding to the slot 106 is disposed under the top plate 105. The cover 102 has an actuating member 108, which is inserted into the slot 106 and actuates the sensor 107 when the cover 102 is closed. Although the scanner can detect the opening state of the cover, the inserting of the actuating member 108 will be affected when a large-format document blocks the slot 106, and the document may be punched through. In addition, this scanner has a complicated structure, and the desired function can be achieved with special designs of the cover and the casing.

### SUMMARY OF THE INVENTION

It is therefore an object of the invention to provide a scan device capable of detecting an open/close state of a cover, wherein the open/close state of the cover is detected according to ambient light without influencing the closing of the cover and the preheating of the lamp or other procedures may be made accordingly.

To achieve the above-identified object, the invention provides a scan device including a body, a scanning module disposed in the body, a cover pivotably connected to the body, an optical sensor and a power supply controller. The body has a scan platen, on which a document is placed. The optical sensor, which is disposed either on the cover or the body, receives ambient light and correspondingly outputs an open-state signal. The power supply controller, which is electrically connected to the optical sensor, controls the power supplied to the scanning module according to the open-state signal.

Sensing the ambient light to detect the open/close state of the cover can achieve a reliable detection effect. In addition, the procedure of detecting the open/close state of the cover can control a lamp preheating procedure, a printing unit preheating procedure and a document size detecting procedure, so that the time may be saved.

### BRIEF DESCRIPTION OF THE DRAWINGS

FIG. 1 shows a device of controlling an ON/OFF state of a scanner power by a cover, as disclosed in Taiwan Patent Publication Number 566778.

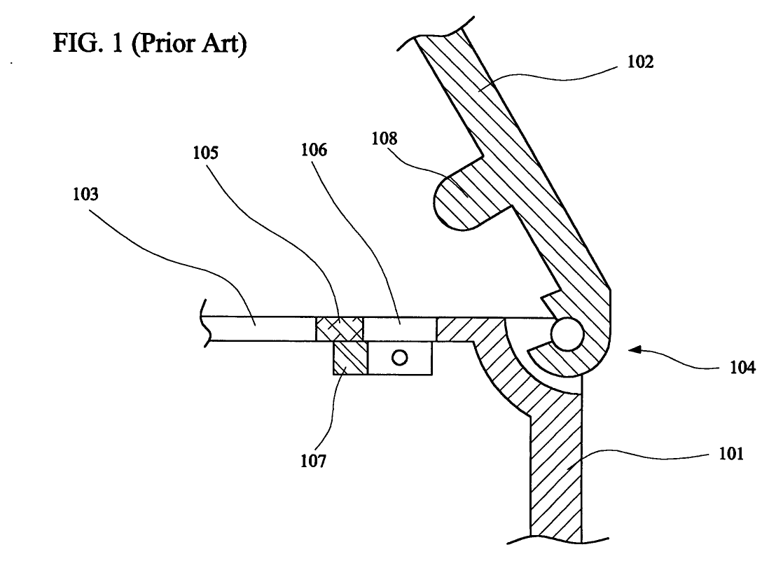

FIG. 2 shows a scan device capable of detecting an open/close state of a cover according to a first embodiment of the invention.

FIG. 3 shows a scan device capable of detecting an open/close state of a cover according to a second embodiment of the invention.

FIG. 4 shows a scan device capable of detecting an open/close state of a cover according to a third embodiment of the invention.

### DETAILED DESCRIPTION OF THE INVENTION

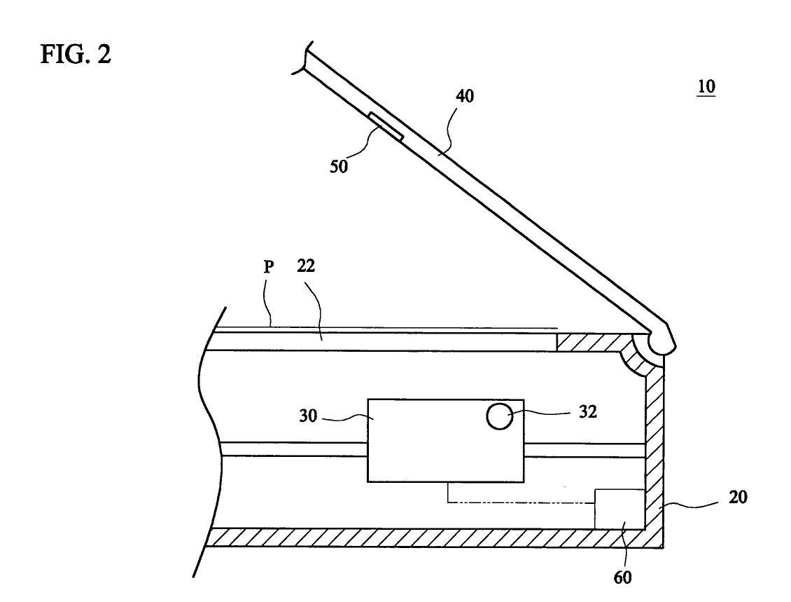

FIG. 2 shows a scan device capable of detecting an open/close state of a cover according to a first embodiment of the invention. Referring to FIG. 2, the scan device 10 capable of detecting the open/close state of the cover according to this embodiment of the invention includes a body 20, a scanning module 30, a cover 40, an optical sensor 50 and a power supply controller 60.

The body 20 has a scan platen 22, on which a document P may be placed. The scanning module 30 including a lamp 32 is disposed in the body 20. The cover 40 is pivotably connected to the body 20. The optical sensor 50 disposed on the cover 40 receives ambient light and correspondingly outputs an open-state signal when the cover 40 is opened. For example, the optical sensor 50 may include a light dependent resistor. The resistance of the light dependent resistor is obtained using a voltage-dividing circuit, and the open/close state of the cover may be determined. It is to be noted that the optical sensor 50 disposed on the cover 40 may directly face the scan platen 22 or face a top surface of the body 20 around the scan platen 22.

The power supply controller 60 electrically connected to the optical sensor 50 controls the power supplied to the scanning module 30 according to the open-state signal. For example, the power supply controller 60 controls the lamp 32 to preheat according to the open-state signal. Such a preheating procedure is usually performed after the scan device enters a power sleep mode.

Thus, the optical sensor 50 can sense the ambient light when the cover 40 is lifted up, and cannot sense the ambient light when the cover 40 is closed. Alternatively, when the luminance of the ambient light sensed by the optical sensor 50 changes from dark to bright, it means that the cover 40 is lifted up; and when the luminance of the ambient light sensed by the optical sensor 50 changes from bright to dark, it means that the cover 40 is closed.

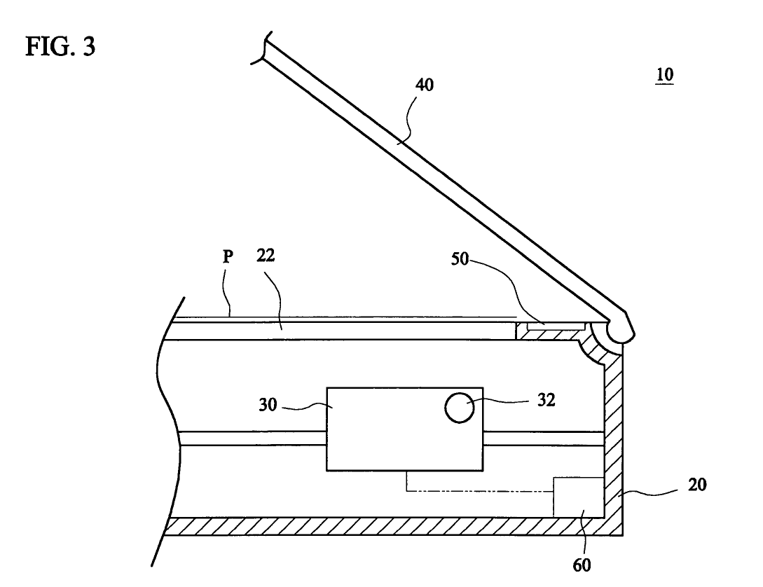

FIG. 3 shows a scan device capable of detecting an open/close state of a cover according to a second embodiment of the invention. As shown in FIG. 3, this embodiment is similar to the first embodiment except that the optical sensor 50 is mounted on the body 20 in the second embodiment, and detailed descriptions of the similar parts will be omitted.

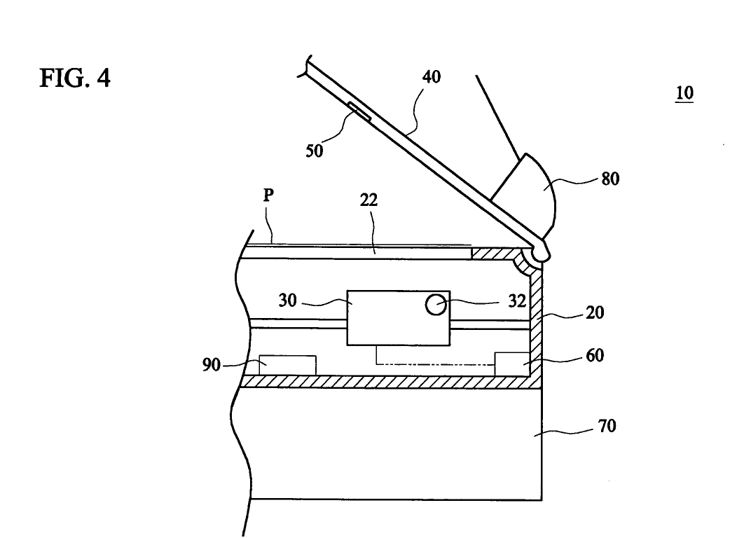

FIG. 4 shows a scan device capable of detecting an open/close state of a cover according to a third embodiment of the invention. As shown in FIG. 4, in addition to all the members included in the first embodiment, the scan device of the third embodiment further includes a printing unit 70, and the power supply controller 60 controls the printing unit 70 to preheat according to the open-state signal. In addition, the scan device 10 further includes an automatic document feeder 80 and the power supply controller 60 disables the automatic document feeder 80 from transporting a document according to the open-state signal. Thus, it is possible to detect whether the hinge of the automatic document feeder is located at the normal position, and it is possible to prevent the automatic document feeder from transporting the document in an improper condition. Furthermore, this scan device 10 further includes a document size detector 90, and the power supply controller 60 enables the document size detector 90 to detect the size of the document according to the open-state signal. Because detecting the size of the document before the cover is closed may have good and reliable effects, the invention may also be integrated with this function so that good document size detection effects may be provided.

In the scan device of the invention, even if the user has forgotten to take the document out and the document still remains on the glass platen, the open/close state of the cover still can be detected. In addition, only one optical sensor has to be disposed in the scan device of the invention without influencing the effect of detecting the open/close state of the cover. Thus, it is unnecessary to use the prior art method of detecting the open/close state of the cover with the complicated and expensive electromagnetic field or transceiver. Furthermore, the optical sensor may be disposed on a surface, which has the same level as the contact surface of the cover or body, such that the large-format document will not be punched and the closing of the cover will not be influenced as in the '778 patent.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A scan device, comprising:
a body having a scan platen, on which a document is placed;
a scanning module disposed in the body;
a cover pivotably connected to the body;
an optical sensor, which is disposed either on the cover or the body, for receiving ambient light and correspondingly outputting an open-state signal; and
a power supply controller, which is electrically connected to the optical sensor, for controlling power supplied to the scanning module according to the open-state signal.

2. The scan device according to claim 1, wherein the scanning module comprises a lamp, and the power supply controller controls the lamp to preheat according to the open-state signal.

3. The scan device according to claim 1, further comprising a printing unit, wherein the power supply controller controls the printing unit to preheat according to the open-state signal.

4. The scan device according to claim 1, further comprising an automatic document feeder, wherein the power supply controller disables the automatic document feeder from transporting the document according to the open-state signal.

5. The scan device according to claim 1, further comprising a document size detector, wherein the power supply controller enables the document size detector to detect size of the document according to the open-state signal.

6. The scan device according to claim 1, wherein the optical sensor comprises a light dependent resistor.
